(19) United States
(12) Patent Application Publication
(10) Pub. No.: US 2013/0043333 A1
(43) Pub. Date: Feb. 21, 2013

(54) Method and System For Crushing and Disposing Fluorescent Lamp Bulbs

(71) Applicant: Troy W. Livingston, Northbrook, IL (US)

(72) Inventor: Troy W. Livingston, Northbrook, IL (US)

(21) Appl. No.: 13/585,007

(22) Filed: Aug. 14, 2012

Related U.S. Application Data
(60) Provisional application No. 61/575,373, filed on Aug. 19, 2011.

(51) Int. Cl. B02C 19/00; B02C 23/04; B02C 25/00; B02C 19/18

(52) U.S. Cl. 241/23; 241/27; 241/232; 241/65; 241/36

(57) ABSTRACT

An improved method and machine for safely and properly crushing fluorescent lamps or tubes of various types, various sizes and various configurations is described. The inventive system discloses a machine comprising a housing which can be placed in a building or facility such a hardware store or other retail establishment which is easily accessible to the public. Rewards may be provides to the party/person disposing the fluorescent tubes such as redeemable coupons, etc, The machine thus encourages the public to safety crush and dispose fluorescent lamp tubes and thereby tends to increase the rate of recycling of fluorescent tubes. the invention also proves heating means for more quickly and safely reducing the hazardous mercury vapor contained in the crushed tubes.

### BACKGROUND OF THE INVENTION

This application claims the rights to the filing date of U.S. provisional application Ser. No. 61/575,373 filed on Aug. 19, 2011 in the name of Troy W. Livingston, the same inventor herein, and this application having the same Title as said provisional application.

This invention relates to the disposal of chemical wastes, and particularly to the collection, storage, crushing and disposal of fluorescent lamps and the processing of mercury vapors emitted from said fluorescent lamps, and rendering said mercury vapors to a non toxic state as per Federal and Sate requirements.

Fluorescent lamps are of many shapes and sizes including elongated bulbs/tubes of several feet in length as well as coiled bulbs and compact bulbs. One universal type is a compact fluorescent lamp (CFL) that is about 2-8 inches in length and has a tube body diameter of 2-4 inches, another common type of fluorescent lamp comprises an elongated tube four feet in length and tube body which is 1-2 inches in diameter, and a third common type is in the form of a circle 4-12 inches wide and the tube body which is 1-2 inches in diameter.

All of the fluorescent lamps contain mercury and toxic mercy vapor as well as a mix of exotic and common metals in a powdered phosphorescent coating inside a glass tube. Modern four feet long fluorescent tubes have 8-10 mg of mercury. Older tubes may have several times that amount of mercury. The phosphor in a common “cool white” bulb is a complex mixture containing mercury and various exotic metal and common metals. During the working life of a fluorescent bulb or lamp the mercury is gradually absorbed into the phosphor. At the end of the lamp's useful life up to 98% of the mercury has been absorbed. This makes the phosphorescent powder dangerously toxic and must be contained.

In one current practice of recycling spent lamp tubes/bulbs, the tubes are placed in corrugated boxes and shipped a disposal center. Shipping the spent tubes from one site to another often results in tube breakage, or damage and opening of the container thus exposing workers in the vicinity to the toxic mercury vapors. Further, such supping practice is expensive to the party disposing the lamps and hence is not conducive to improving the recycling rate.

There are commercially available fluorescent lamp disposable devices which appear to comprise modified 55 gallon cans with various entry ports to accept various types of fluorescent lamps. Since these prior devices are operated by employees, no provisions have been made or components provided, to distinguish and separate fluorescent bulbs from unacceptable objects, nor to protect the crushing components from damage by unacceptable objects, nor to provide components for automatically separating fluorescent lamp bulbs from other waste.

In the USA the recycling rate for fluorescent lamps is quite low in the 25% range. Basically this means that fluorescent tubes are disposed in or with the same garbage as all the other household garbage, or with recycled nontoxic and useable materials such as paper or cardboard or plastics.

In Europe the recycling rate for fluorescent lamps is about 80%. The present invention is intended to make recycling of fluorescent lamp tubes easier, safer, and importantly to promote and raise the rate of recycling in the USA and throughout the work such as by rewarding the party/person disposing the lamps with redeemable coupons or merchandise credits.

### SUMMARY OF THE INVENTION

A basic object of the present invention is to provide an improved fluorescent lamp bulb/tube crushing and disposal method and system. More particularly, the present invention provides an improved method and machine for safely and properly crushing fluorescent lamps or tubes of various types, various sizes and various configurations. The inventive system discloses a machine comprising a housing which can be placed in a building or facility such a hardware store or other retail establishment which is easily accessible to the public thereby encouraging the public to safely crush and dispose fluorescent lamp tubes and thus increase the rate of recycling of fluorescent tubes. As one incentive to dispose of the fluorescent bulbs, rewards such as redeemable coupons may be offered to the party disposing the fluorescent bulbs in the inventive machine. The invention discloses a unique crushing system having two cooperating crushing wheels positioned adjacent one another. One of the crushing wheels is pivot able and spring biased to a closed position to crush fluorescent tubes. Should an object that is inserted to be crushed is of a hard damaging material, the pivoting wheel is forced outwardly by the hard material. The pivoting wheel opens against the spring bias and allows the hard object to drop through the open spacing between the wheels thereby preventing damage to the machines and the other components of the machine. The invention also provides heating means for quickly and safely reducing the volatility of the crushed tubes. Further, the invention provides means for separating fluorescent lamps/tubes residue and non fluorescent waste.

The foregoing features and advantages of the present invention will be apparent from the following more particular description of the invention. The accompanying drawings, listed herein below, are useful in explaining the invention.

### DESCRIPTION OF DRAWINGS

FIG. 1 is an isometric of the housing of the present invention;

FIG. 2 is a side section view of the inventive fluorescent lamp crusher machine to show the components of the machine mounted in a mercury vapor sealed housing;

FIG. 3 is a view of the crushing wheels of the fluorescent lamp crushing machine and the supporting components;

FIG. 4 is a view of the crushing wheels in the process of crushing a compact fluorescent bulb;

FIG. 5 is a view of the crushing wheels useful in explaining the function of the blades attached to the wheels;

FIG. 6 is a view of the crushing wheel depicting the open or pivoted position of one wheel that protects the pair of wheels from damage;

FIG. 7 is an isometric view to show die heating band provided for the fluorescent bulb residue container and the clamping mechanism for the band;

FIG. 8 is a top view of the container of FIG. 6 with the clamping mechanism in a closed mode;

FIG. 9 is a top view of the combiner of FIG. 7 showing the clamping mechanism in an open mode;

FIG. 10 shows an alternative embodiment of the crushing wheels shown in the previous figures;

FIG. 11 show a second alternative embodiment of the crushing wheels; and,

FIGS. 12A and 12B show graphs of the heating cycle for the mercury vapors released by the fluorescent lamp tubes/bulbs.

### DESCRIPTION OF THE INVENTION

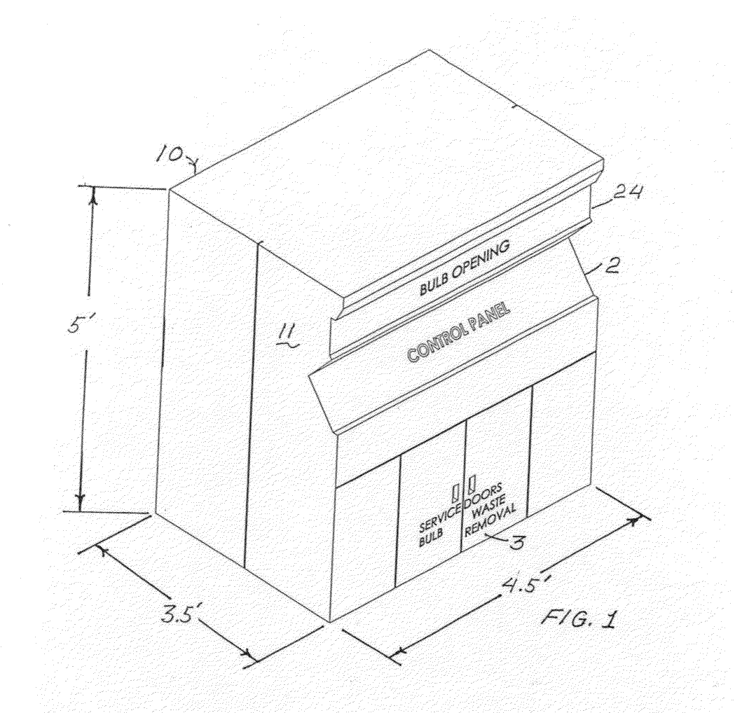

FIG. 1 is an isometric view of the noosing 11 of the inventive fluorescent lamp/tube crushing machine 10 and depicts the general configuration of the housing. The overall dimensions of one embodiment of housing are: 4.5 ft wide by 5 ft high by 3.5 ft in depth. The indicated bulb opening 24 is long enough to conveniently accept the common elongated fluorescent tubes that are four feet in length. Also the bulb opening 24 is wide enough to accept compact fluorescent tubes, but is narrow enough to limit the size of large objects that can he inserted through the opening, as a safety precaution. A control panel 2, including suitable know type start button, ready lights and a cancel button are mounted on housing 11. Service doors 3 for accommodating the insertion and removal of a container for fluorescent bulb residue are conveniently mounted in front of the housing 11.

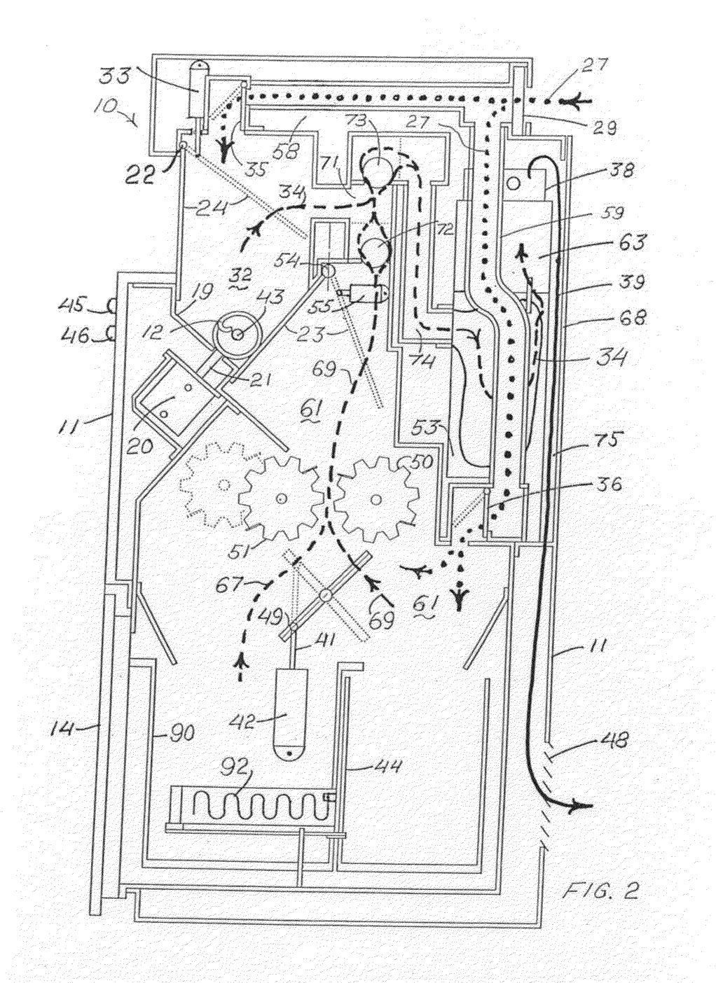

FIG. 2 is a side view partly in section of the housing 11 depicting the inventive fluorescent lamp crushing machine/crusher 10. The machine 10 is intended to be positioned in a location easily accessible to the public on the floor of a retail store or adjacent an entrance to a store to receive fluorescent lamps that are to be crushed. The machine is electrically powered and includes internal controls which are activated in response to the opening of a lamp receiving door (as will be described), and a start button and other button commands from the party/person disposing a fluorescent lamp or lamps.

As depicted in FIG. 2, the inventive fluorescent lamp bulb crushing machine 10 comprises an enclosed rectangular housing 11 including various panels, doors, channels and mounting support surface as will now be described.

To initiate the machine operation, the person (the user) disposing a fluorescent lamp bulb 12 pushes lamp receiving door 24 open. The top of door 24 is hinged to the housing 11 and is mounted to be pivotable about hinge 22 point biased to be closed as by suitable spring means, not shown. The door can be pushed open by a user to move to the dotted position indicated in FIG. 2 to provide an elongated opening to receive a fluorescent bulb 12 as long as four feet or a CFL (compact fluorescent bulb), or a circular bulb. The bulb 12, depicted in FIG. 2 is a CFL. The opening of door 24 causes a “ready” light to be illuminated. Also a vacuum motor 38 starts immediately upon the opening of the door 24 and runs for at least fifteen seconds (even if no bulb is inserted through door) Next the user drops the bulb 12 into bulb receiving tray 32 and then pushes start button 45 to initiate the bulb crushing operation. After a four second timed delay, the crushing operation starts. This four second delay is provided to give the user an opportunity to assure that she/he has inadvertently dropped a non intended object such as car keys into the tray. A cancel button 46 is provided for the user to stop (abort) any further operation and to retrieve any non-intended object, or to stop operation of the machine for any other reason. After the four second delay period, the machine operation will proceed and the cancel button 46 will not stop operation of the machine.

Bulb 12 now rests on receiving tray 32 which is triangular in shape and is formed by a panel 19 and a crushing chamber access door 23. As stated above, tray 32 is sufficiently long to accept a common forty-eight long fluorescent tube. Further tray 32 is sufficiently wide and deep to accept the universal CFL (compact fluorescent luminescent) tubes and the common circular types of fluorescent tubes. When the receiving door 24 closes, and a tube 12, the air cylinders 20, mounted adjacent tray 32, are energized to drive plungers 21 of spaced air cylinders 20 to strike and break the luminescent tube(s) in the tray. At least two identical air cylinders 20 are mounted in spaced relation adjacent tray 32. As can be appreciated, the various cylinders 20 operate in concurrent relation and are particularly useful for breaking elongated fluorescent bulbs which may be up to four feet in length. The plungers 21 of air cylinders 20 effectively break the elongated bulb into manageable pieces for subsequent crushing by the crushing wheels. When the door 23 is closed it forms part the angled bottom of tray 32. Door 23 is hinged to a bracket 54 and is controlled to open and close by an air cylinder 55. After a three second delay from the time the air cylinder plunger 33 extends to close receiving door 24, an air cylinder 55 is energized to move crushing chamber access door 23 to open to the position indicated by the dotted lines. When door 23 opens the bulbs or other objects in tray 23 fall down. The panel 19 forming the other part of the bottom of tray is also angled downwardly to assure that when door 23 is opened, any luminescent tube parts drop down and out of tray 32. (Two seconds after door 23 opens, the plunger of cylinder 55 closes door 23).

Concurrently with the opening of chamber door 23, the crushing wheels 50 and 51 are energized to start rotating. The bulb 12 or broken pieces of bulb 12 fall into chamber 61 and onto the rotating crushing wheels 50 and 51 where the bulb 12 and any pieces of tube are crushed.

Note that the timing for closing and opening of the doors is necessary to ensure that the housing 11 is fully sealed from the outside atmosphere so that no mercury vapors are released to the ambient air.

As shown in FIGS. 2 and 3-6, crushing wheels 50 and 51 each have outwardly extending crushing teeth, generally labeled as 52, on their periphery. The wheels are of the same size and are seven inches in diameter and ten inches in axial length. In one embodiment, the teeth of the wheels are frusto conical is shape and are about one inch high. (The term frusto-conical is used herein to refer to a pyramidal shaped object that has Its peak cut off and made flat and thus is parallel to a flat bottom).

Wheel 50 is driven by a suitable electric rector, not shown. Wheel 50, in turn drives wheel 51 via chain 55, see FIG. 6. The chain is shown in FIG. 6, but for purposes of clarity of the other components in the drawings the chain is not shown in FIGS. 2-5. The connection of chain 55 between the wheel 50 and 51 causes the wheels to rotate in opposite directions, i.e., wheel 50 rotates in a counter clockwise direction and wheel 51 rotates in a clockwise direction. The teeth of one wheel are interleaved with the teeth of the other wheel. Flat ended teeth are selected in order to properly crush the bulb 12 and the broken pieces of bulb without digging into and getting caught in the broken pieces which might result in possible clogging of the teeth and wheels.

Note also that the crushing wheels 50 and 51 are mounted to have about a three-quarter inch spacing between the teeth of wheel 50 and the teeth of wheel 51. The separation between the teeth results in the crushing of the bulbs without grinding or pulverizing the bulbs or bulb pieces. Additional smaller teeth may be provided on wheels 50 and 51 to crush fluorescent tubes of small diameter.

The crushed bulb 12 and bulb pieces fall down past wheels and are directed by pivoting diverter plate 49 to a fluorescent bulb residue container/barrel 90 made of steel. Suitable sensors 43 control the positioning of diverter plate 49. The sensors 43 control an air cylinder 42 that has its plunger 41 affixed to plate 49 to position the plate to guide the fluorescent residue to container or barrel 90. When the sensors 43 detect an object that is not a fluorescent tube, air cylinder 42 is activated to move plate 42 to the position indicated by the dotted line to guide the object to a non fluorescent waste container 12.

An important and unique feature of the crushing assembly 47 is that wheel 50 is mounted on a stationary axle while wheel 51 is mounted on an axle that can swing or pivot from a first or closed position and a second or open position, indicated by the dotted lines in FIGS. 1 and 6. The purpose of the aforementioned swing is to protect the wheel from damage should hard unacceptable objects such as hard non crushable objects are dropped through door 24 into tray 32. As will be described in detail herein after, when such a non crushable object engages the wheels, wheel 11 will swing out to the dotted line position and the object will drop down between the wheels into a trash bin 44. Note that when wheel 11 swings out and air cylinder 42 will be energized to move diverter plate 43 to position indicated by the dotted lines to guide the unacceptable object to a non fluorescent bulb waste container 44.

Another important feature of the invention is that all breaking and crushing of the fluorescent bulbs occurs in a folly closed and safe environment and also meets State and Federal Regulations. Refer now to FIG. 2 and particularly to the heavy arrow lines thereon. Dotted arrow line 27 depicts the ambient air entering the machine housing 11 via filter 29. The filtered air moves through channel SB past the one way air valve 35 into the interior of the housing 11. The open position of valve 35 is indicated by the dotted lines. The filtered air also moves down channel 59 through a second air input valve 36 to the bulb crushing chamber 61. Both air valves 35 and 36 are mounted in horizontally hinged position to housing 11 to close by gravity when the machine 10 is in a passive or none operating mode.

As stated above as soon as the receiving door 24 is pushed open, the vacuum pump 38 starts and air indicated by arrow line 39 is exhausted from housing 11 by the pump 38 and concurrently as air is drawn into housing 11, as described above.

As stated above soon as the user opens the bulb receiving door 24, the vacuum pump motor is energized for a period of 15 seconds. After the user places or drops the spent fluorescent bulb in the tray 32, and the receiving door 24 is closed, she/he presses the start button 45 to initiate the crushing cycle, and the vacuum pump continues to run. Thus the vacuum pump 38 has now been activated to exhaust air from the housing 11 and particularly from the tray chamber 32 and crushing chamber 68, and to draw ambient air into the housing via channels 58 and 59. As indicated by the dashed line 34, exhaust air from chamber of tray 32 is drawn up through channel 71 and one way ball valve 73, through channel 74 as indicated by dashed line 34, air filter 53, and through activated charcoal filter 63 to filter out the mercury vapor. The filtered and cleaned air indicated by the solid line 39 thence exits through channel 75 and vent 48 of housing 11 to the atmosphere. Mercury vapors created by the breaking and crushing of the fluorescent bulbs are fully filtered out of the exhaust air by charcoal filter 63.

Also as depicted in FIG. 2, by the heavy dashed lines 67 and 69 air is also drawn from the crushing chamber 61 as soon as the vacuum pump 38 is activated. Ball valve 73 is a one way valve positioned to allow flow of air upward and outwardly from crushing chamber 61. Thus as soon as vacuum pump 38 is activated air is caused to be drawing the crushing chamber 61 via ball valve 72, through channel 71, ball valve 73 and channel 74. Valves 72 and 73 are mounted in series, and as air ix exhaust via channel 71 both valves 72 and 73 are open to enable a full flow of exhaust air. When the machine is in a passive mode, both ball valves 71 and 72 are closed by gravity and ambient air is prevented from entering the housing 11. As indicated by the line 34 the exhaust air is expelled via the paths previously described to pass through activated carbon filter 63 immediately upon opening door 24 and continues throughout the machine operation.

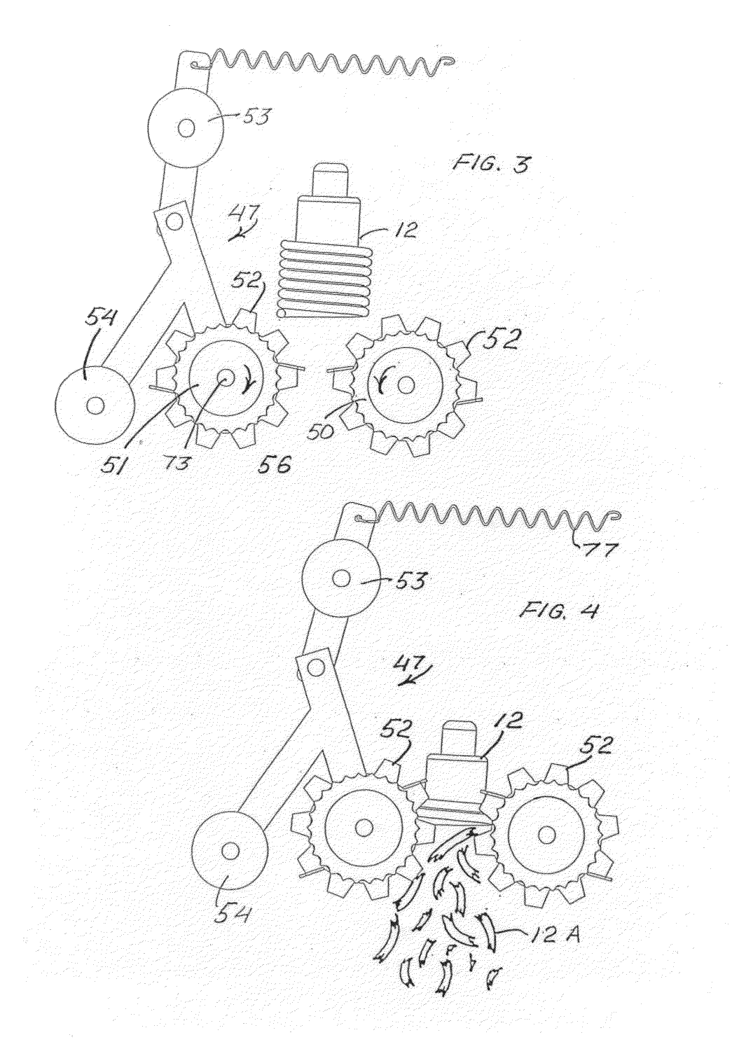

FIGS. 3-5 are additional detailed view of the overall crushing assembly 47 wheels 50 depicting various modes of the crushing cycle. Refer to FIG. 3 which depicts the crushing of a CFL (compact fluorescent tube) 12. FIG. 3 shows a CFL tube 12 at a point just prior to failing into the rotating crushing wheels 50 and 51. FIG. 4 depicts the crushing of bulb 12 by the teeth 52 of wheels 50 and 51. Note that as depicted in FIG. 4, the teeth 52 of the two wheels do not engage each other and hence the bulb 12 is crushed hut not ground down. The bulb 12 is crushed into small pieces that are guided into the bulb collection container by diverter plate 49.

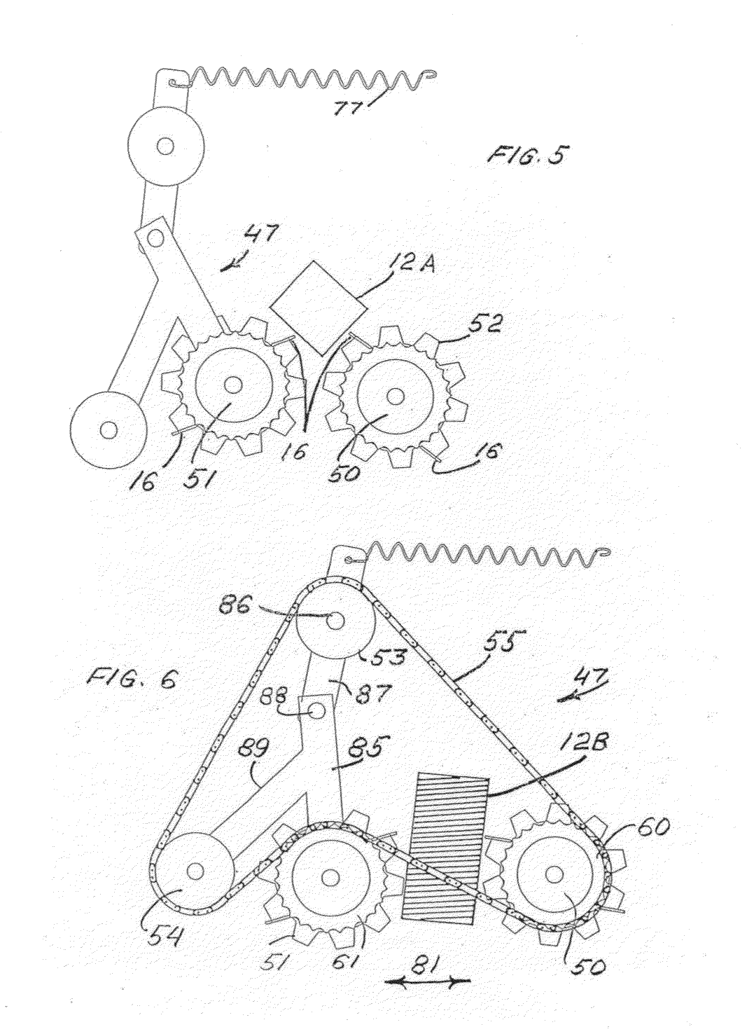

The function of blades 16, on wheels 50 and 51 is depicted in FIG. 5 showing a box 12A that gets fed to the crushing wheels 50 and 51. When a relatively light box 12 A is struck by the flat teeth 32 of the wheels, the box may tend to bounce and “float” above the rotating teeth and the object will not be engaged and crushed. However, blades 16 which extend outwardly of the flat teeth 12 and are somewhat flexible will engage and push box 12A downwardly to be fed to the passage between the wheels and the box 12A will be crushed.

As shown in FIGS. 3-5, wheel 51 is biased to a closed position by the force of spring 77 connecting through arms 87 and 85. As depicted in FIG. 6, when the teeth 52 of the rotating wheels 50 and 51 engage a non crushable object very high forces will be generated to push the wheels apart. The spring 77 force tending to hold wheel 51 in a closed position will be overcome and wheel 51 will move (swing, pivot) outwardly. The passageway between wheels 50 and 51, indicated by the arrow line 81, will widen and the non crushable object 12B will drop through the passageway into the non fluorescent waste container 44. Swinging or pivoting wheel 51 thus provides the important function of protecting the wheels 50 and 51, as well as the overall machine 10 against damage.

Refer now to FIG. 6 for an additional detailed explanation of the operation of swinging/pivoting wheel 51. The motor drive shaft rotates wheel 50. In turn, a chain 55 connects sprocket 60 on wheel 50 to drive sprocket 61 on wheel 51. As the wheel 51 pivots outwardly and opens the spacing between the two wheels (as described above) provision must be made to assure that the chain remains in a tight engaging configuration around both wheels to properly and synchronously drive wheel 51. The crushing wheel assembly 47 depicted in FIGS. 3-6 has been developed to assure that the chain 55 remains taut and does not sag in either the closed or open mode. A vertically extending arm 85 has its lower end mounted to the axle of wheel 51. The upper end of arm 85 is mounted to pivot on pin 88 that in turn is affixed to the lower end of arm 87. The upper end of arm 87 is affixed to tension spring 77. Arm 87 pivots about stationary pin 86. An idler wheel 53 is mounted on the pin. An angled extension 89 is provided for arm 85. An idler wheel 54 is mounted on the distal end of extension 89.

As depicted in FIG. 6, drive wheel 50 is mounted to rotate in a counter clockwise to move the non crushable object 12B downwardly. The path of the chain 55 goes from the bottom of sprocket 60 to the top of sprocket 61 in a configuration to drive wheel 51 in a clockwise direction to thus cooperate with wheel 50 to move object 12B downwardly. The path of the chain 55 continues from the top wheel 51 down and around idler wheel 54, up and around the top of idler wheel 53, and thence down and around drive wheel 50.

As wheel 51 is moved outwardly, arm 85 pivots on pin 88 and moves arm 87 about pin 86 to overcome the tension force of spring 77. Idler wheel 54 which is mounted on angled extension 89 is positioned to adjust or “take-up” any slack in chain 55 as it is moved outwardly and back to its initial lamp crushing position This pivoting movement functions to maintain the chain 55 in a taut condition throughout the complete movement of wheel 51 from its initial bulb crushing position to its open position, and the return of wheel 51 from its initial bulb crushing position to its open position, and the return of wheel 51 to its initial position. The tension of spring 77 returns the wheel 51 to its initial position, as soon as the non crushable object 12A drops past the wheels 50 and 51 and the force effected by the object 12A is removed. As stated above, the moving or swinging action wheel 51 provides the important function of protecting the wheels 50 and 51, as well as the overall machine 10, against maliciously intended damage.

Refer now to FIGS. 2 and 7. FIG. 7 is an isometric view of the fluorescent bulb residue container 90 which is depicted in section in FIG. 2. Mercury evaporation from the residue of a fluorescent lamp takes approximately two weeks at room temperature for the mercury vapor contamination to fall below the hazardous levels. Data has shown that the mercury vapor volatilization rate varies with temperature.

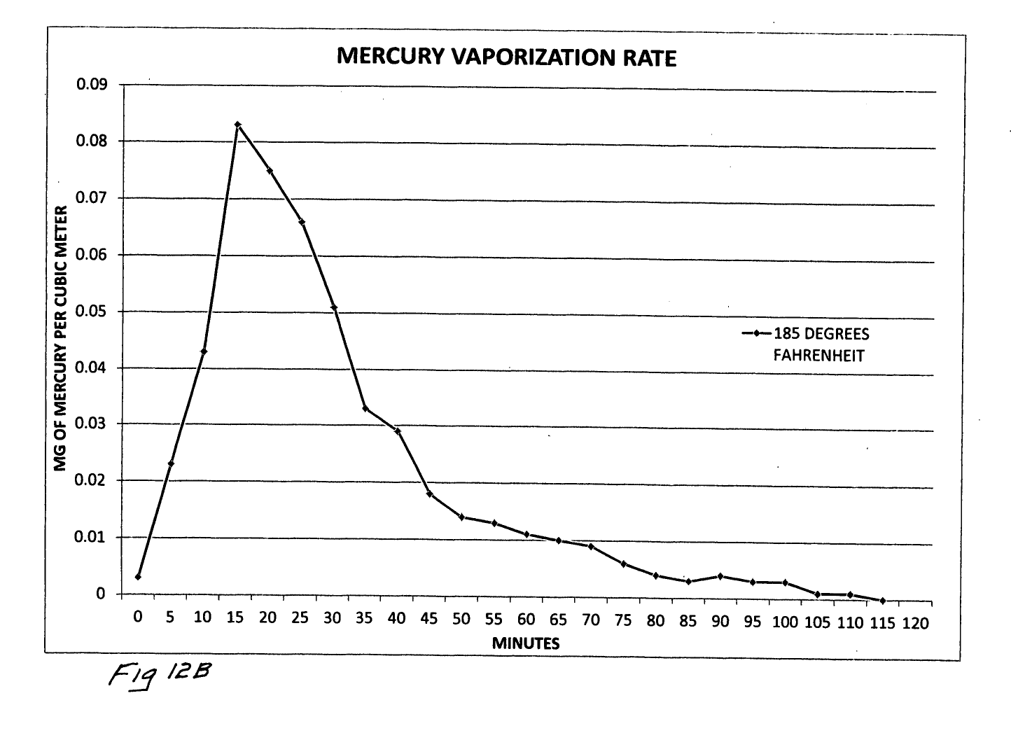

Refer now to the graphs shown in FIGS. 12A and 12B. The graph of FIG. 12A shows vaporization rates when the mercury residue is heated to 185 degrees F. and when the residue is heated to 210 degrees F. The higher heated mercury evaporates at a faster rate. In the inventive system the fluorescent residue is heated to about 185 degrees F. to decease the time period to reduce die toxicity of the mercury vapor to non hazardous levels from two weeks to approximately one hundred and ten minutes, that is to essentially 0.005 mg of mercury per cubic meter, well below Federal and State requirements. While it has been found that if the temperature is increased to 210 degrees F., the mercury vapor can be rendered less toxic in a shorter period, as shown in graph of FIG. 12A, unpleasant odors begin to emanate when the fluorescent tamp residue is heated to a temperatures above 185 degrees F. Therefore, and as shown in FIG. 12B, heating the residue to 185 degrees F. has been found preferable, and basically it requires only a few minutes longer to render the residue non hazardous.

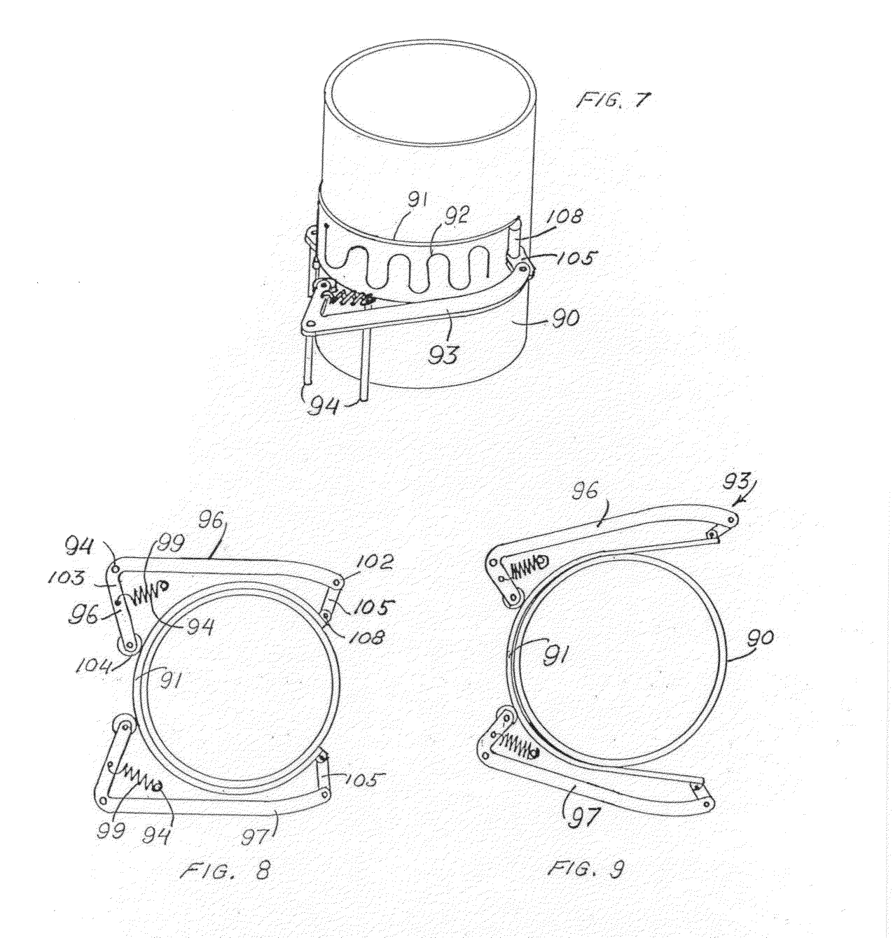

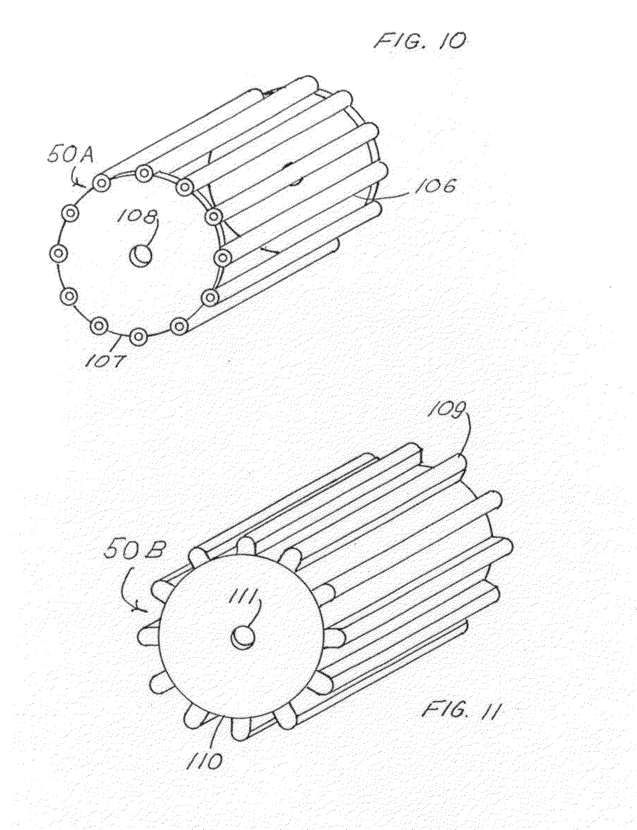

Thus, one embodiment of the heating assembly of the invention includes an electric heater 92 to heat container 90 and the fluorescent lamp residue to 185 degrees to accelerate rate of volatilization of the mercury vapor. Refer now to FIGS. 2 and 7-9. FIG. 2 shows a steel barrel container 90 for the luminescent bulb residue mounted on the floor of housing 11. The container 90 is mounted on a platform that may be rolled out of housing 11, so that the residue container can is easily inserted and removed. The housing 11 includes suitable doors 14 for accommodating the insertion and positioning of container 90 in housing 11. An electric powered heating band 91 is mounted to surround a portion of the barrel 90 to heat the barrel and any contained luminescent bulb residue. The heating band 91 has a conductive heating coil 92 embedded therein. In one embodiment band 91 is about five inches wide extends about ¾ of the circumference of the barrel 90 and is powered to heat barrel 90 and the contained fluorescent lamp residue to about 185 degrees F. for the purpose described above.

FIGS. 7-9 show a clamp type assembly 93 that positions band 91 around barrel 90. Downwardly extending rods generally labeled 94 are affixed to the floor of housing 11 to support the clap assembly 93 around barrel container 90. Barrel 90 has to be removed front housing 11 when it is full of luminescent tube residue, and reinserted and positioned within housing to be in position to receive additional residue. The platform is mourned on rollers and enables convenient positioning and the barrel allows for easy removal and reinsertion. The clamp assembly 93 serves the foregoing purpose.

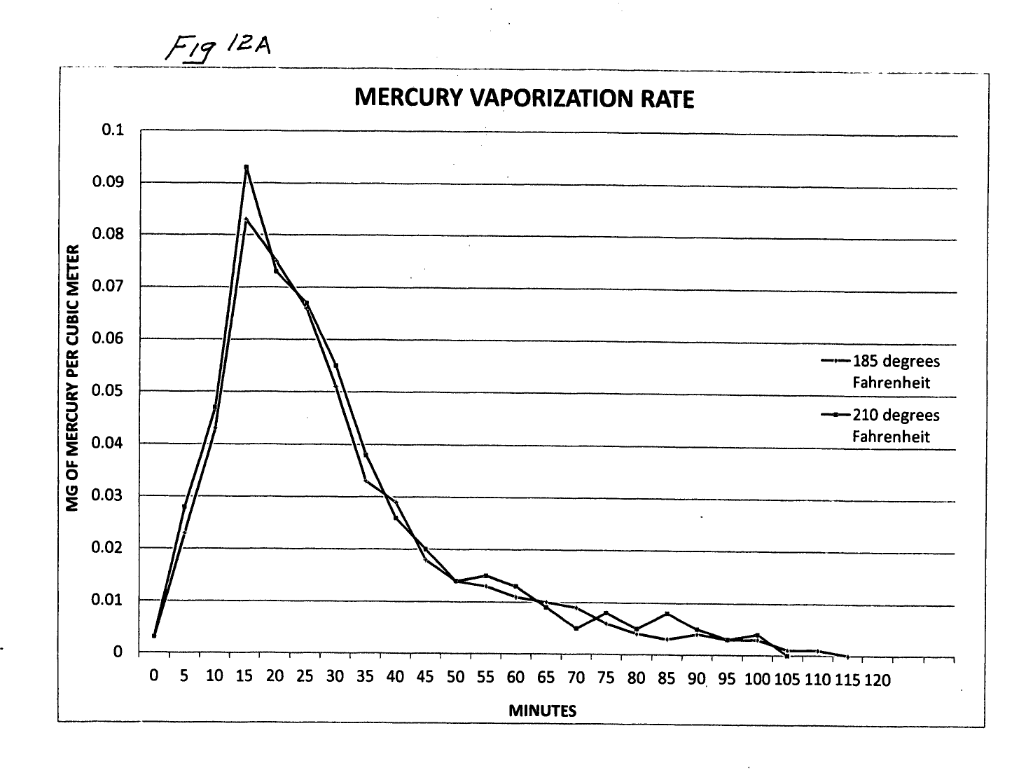

FIGS. 10 and 11 show alternative embodiments of the crushing wheels. The size and operation of the alternative embodiments 50A of FIGS. 10 and 50B of FIG. 11 are essentially the same as those of wheel 50 of FIGS. 2-6. Note of course that wheels 50 and 51 are identical. Wheel 50A of FIG. 10 is constructed to have the crushing teeth formed as tubes 106 mounted in spaced relation on the periphery of a round end plates 107 that have an opening 108 to mounted on the wheel axle. Wheel 50B of FIG. 11 is constructed to have the crushing teeth formed as gear-like protrusions 109 formed on the periphery of a solid cylinder 110. A center opening in cylinder receives the wheel axle. As stated above the size and operation wheels 50A and 50B are identical to those of wheel 50. These alternative embodiments appear to be somewhat more inexpensive to manufacture.

While the invention has been particularly shown and described with reference to preferred embodiments thereof, it will be understood by those skilled in the art that various changes in form and details may be made therein without departing from the spirit and scope of the invention.

1. A method of crushing fluorescent lamps which contain mercury and mercury vapors and collecting the glass and metal components as a residue thereof wherein in said lamps and said components include relatively light crushable materials, comprising
a) inserting fluorescent lamps through a door in a crasher machine housing;
b) providing a first wheel mounted on a stationary rotating axle and a second wheel on a pivotable axle;
c) biasing said pivotable wheel to a closed position adjacent said first axle to crush said lamps between said wheels;
d) feeding fluorescent lamps to be crushed to said wheels;
e) crushing said fluorescent lamps to provide fluorescent lamp residue;
f) pivoting said second: wheel outwardly in response to an object of a hard material, such as the ceramic objects in said fluorescent lamp that can not be crushed by said wheels and thus providing a passageway for the non crushable object to pass through said wheels;
h) returning said pivoting wheel to said closed position.

2. A method as in claim 1 further including the step
a) heating said fluorescent lamp residue to accelerate the rate of evaporation of mercury in said lamp residue.

3. A method as in claim 2 further including the step
a) heating said fluorescent lamp residue to a temperature of 185 degrees to reduce the evaporation of toxic vapor to an acceptable level in approximately one hundred and ten minutes.

4. An apparatus for crushing fluorescent lamps containing mercury and mercury vapors wherein said lamps include light crushable materials, said apparatus comprising
a) a crusher housing having an opening for receiving lamps that are to be crushed;
b) crushing wheels mounted to crushing lamps there between and including a first wheel mounted on a stationary axle and a second wheel mounted on a pivotable axle;
c) frusto conical shaped teeth on said crushing wheel;
d) said wheels being mounted relative to each other to be spaced from one another to crush said lamp into small pieces;
e) spring means for biasing said pivotable wheel to a closed position adjacent said first axle to crash said lamps;
f) said second wheel being moveable outwardly in response to an object of a material that can not be crushed by said wheels to form an opening through which said uncrushed object can pass;
g) whereby said fluorescent lamps can be crushed but damage to said wheels is prevented when non crushable objects are fed thereto.

5. Apparatus as in claim 4 wherein
a) said housing is completed sealed and multiple filters are provide to prevent mercury vapor from escaping from the housing to the atmosphere.

6. Apparatus as in claim 4 further including
a) a container for receiving fluorescent lamp residue including said lamp and its components; and
b) a heater for heating said first cylindrical container to accelerate the evaporation rate of said mercury vapor to a non hazardous level.

7. Apparatus as in claim 6 wherein
a) said heater heats said first container to a temperature of 185 degrees for at least a period of ten minutes to accelerate said evaporation rate.

8. Apparatus as in claim 6 wherein
a) a flexible “C” lamp for positioning said container in said housing;
b) said clamp being spring biased to hold to the sides of said container; and
c) said clamp being shaped to enable convenient removal of said container by overcoming the force of said spring.

9. Apparatus as in claim 6 wherein
a) said healer includes a heat conductive band partially encircling said container;
b) a flexible “c” clamp for positioning, said container in said housing; and
c) said clamp being spring biased to bold to the sides of said container.

10. Apparatus as in claim 4 wherein
a) a receiving tray is provided, for receiving fluorescent tubes including elongated tubes up to four feet in length;
b) a plurality of air cylinders mounted in said housing, the plungers of said cylinder extending into said receiving tray when actuated;
c) said air cylinders being actuated concurrently to shatter and break said elongated tubes.

11. Apparatus as in claim 4 wherein the teeth of said crushing wheels are in the form of elongated tubes mounted on the periphery of a circular plate.

12. Apparatus as in claim wherein the teeth of said crushing wheels are in the form of gears formed on the periphery of a cylinder.

13. Apparatus as in claim 4 further including
a) relatively flexible blades extending outwardly of said teeth to engage relatively larger light objects such as horns to engage said boxes and push said boxes into said crushing teeth.

14. Apparatus as in claim 4 further including
a) a bulb receiving tray;
b) sensors mounted to sense the presence a bulb in said tray;
c) air cylinders having plungers which extend into said tray and are actuatable in response to said sensors to strike and break said bulb.

15. Apparatus as in claim 14 wherein
a) said tray has an angled bottom formed by a door;
b) said door being controlled to open after said air cylinders are actuated to drop and feed said bulb and said bulb pieces into said crushing wheels.
